(19) United States
(12) Patent Application Publication
(10) Pub. No.: US 2006/0286333 A1
(43) Pub. Date: Dec. 21, 2006

(54) Method of and apparatus for weld-bonding workpieces

(76) Inventors: Pei-Chung Wang, Troy, MI (US); Haiyan Zhao, Beijing (CN); Zhipeng Cai, Beijing (CN); Liang Zhou, Beijing (CN); Yaowu Shi, Beijing (CN)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/155,183

(22) Filed: Jun. 17, 2005

(51) Int. Cl. B32B 9/00; B32B 33/00

(52) U.S. Cl. 428/40.1

(57) ABSTRACT

A method of weld-bonding a plurality of workpieces to produce an improved peel joint, includes the formation of an adhesive layer and a weld nugget, and the securing of an adhesive cover relative the workpieces during bonding. The method is operable to partially prevent the migration of fluid adhesive material during construction, and to transfer at least a portion of peel loads to the shear strength of the adhesive material in the produced joint. The method may also be performed utilizing other interconnection means such as clinching or riveting.

### BACKGROUND OF THE INVENTION

1. Field of the Invention

The present invention relates to methods of joining workpieces, and more particularly to an improved method of weld-bonding workpieces that utilizes an adhesive cover to retain and interact with the adhesive material.

2. Discussion of Prior Art

In various industries multiple workpieces are required to be joined to form structural assemblies or parts. These assemblies are often required to carry and transmit to other members vital loads and moments that effect the proper function of the overall structure or machine. For example, in the automotive industry, conventional methods of joining workpieces to form the chassis and other frames, properly function to enable transmission and absorption of forces by the constituent component members. One such method of joining is commonly known as weld-bonding and is shown in FIG. 1.

This method typically utilizes the application of a fluid adhesive material in conjunction with conventional spot welding technology. The bonding strength of the adhesive material enables the number of the welds and/or nugget size and depth necessary to carry a particular load to be reduced. As such, costs associated with producing the weld nugget are also reduced. The construction of these joints, however, present concerns relating to manufacturing costs and performance. For example, where acted upon by gravity, the exposure of the adhesive material enables a portion of the pre-set fluid to escape prior to curing, thereby resulting in material waste. The loss of adhesive material produces a weaker joint than expected and may compromise the structural integrity of the overall structure, if certain precautions are not taken. Finally, the loss of adhesive material may also cause the contamination of assembly-line machinery, which further results in costly down-time to clean.

At locations where the adhesive material/spot-weld combination experiences peeling forces (i.e. outward normal forces acting upon the edge of the joint), this methodology presents further concerns. More particularly, since the weld nugget is typically spaced from the edges of the workpieces, a workpiece experiencing peeling forces must rely upon its flexural strength and the bond strength of the adhesive material to absorb the energy. As new structural materials are developed to produce thinner and lighter, but not necessarily flexurally stronger workpieces, this concerns becomes increasingly greater.

As such, there is an increasing need in the art for a method of joining multiple workpieces that reduces adhesive material waste during assembly, and increases the efficiency of peel load management.

### BRIEF SUMMARY OF THE INVENTION

Responsive to these and other concerns caused by conventional methods of joining, the present invention provides an improved weld-bonding system for reducing the loss of adhesive material during construction of the joint, and increasing the ability of the joint to carry peel loads. This invention provides a method of joining workpieces utilizing the application of fluid adhesive material, an adhesive cover, and conventional welding technology.

More particularly, a first aspect of the present invention concerns a structural assembly comprising a plurality of workpieces, an adhesive material intermediate and in contact with the workpieces, so as to present an exposed adhesive surface, and an adhesive cover configured and fixedly secured relative to the workpieces, so as to cover the exposed adhesive surface. The workpieces are connected, so as to secure the workpieces in a relatively fixed position, and the material is configured to further secure the workpieces in the fixed position.

A second aspect of the present invention concerns a bracket adapted to interact with adhesive material during a method of joining multiple workpieces, wherein the material interconnects the workpieces and presents an exposed adhesive surface. The bracket includes first and second panels. The first panel presents a width greater than the width of the exposed adhesive surface and a length subtending the length of the surface, so that the surface is covered by the first panel, when the bracket is in place. The second panel is connected to and angularly projecting from the first panel, and presents a width less than the width of the exposed adhesive surface and a sufficient depth, so as to be embedded within the adhesive material a minimum distance, when the bracket is in place.

Finally, a third aspect of the present invention concerns a method of joining a plurality of workpieces that includes the following non-sequential steps. First, an adhesive layer is secured intermediate and adjacent the workpieces, so as to interconnect the workpieces in a fixed relative position and present an exposed adhesive surface. Second, an adhesive cover is secured in a fixed position relative to the workpieces and exposed surface, so as to prevent the migration of adhesive in that direction during construction. Third, the workpieces are further interconnected to further secure the workpieces in the fixed position.

Other aspects and advantages of the present invention will be apparent from the following detailed description of the preferred embodiment(s) and the accompanying drawing figures.

### BRIEF DESCRIPTION OF THE SEVERAL VIEWS OF THE DRAWING

A preferred embodiment(s) of the invention is described in detail below with reference to the attached drawing figures, wherein:

FIG. 1 is a perspective view of a prior art weld-bonded assembly, particularly illustrating a plurality of two angled workpieces and an adhesive layer/spot weld combination;

FIG. 1a is a partial cross-sectional view of the prior art weld-bond assembly shown in FIG. 1, particularly illustrating peel load forces acting thereupon;

FIG. 2 is a perspective view of a weld-bonded assembly in accordance with a preferred embodiment of the present invention, particularly illustrating a plurality of two angled workpieces, an adhesive layer/spot weld combination, and a T-bracket adhesive cover;

FIG. 3 is a cross-sectional view of the weld-bond assembly shown in FIG. 2;

FIG. 4 is a fragmentary cross-sectional view of a weld-bond assembly in accordance with a preferred embodiment of the present invention;

FIG. 5 is a cross-sectional view of a T-bracket adhesive cover in accordance with a preferred embodiment of the present invention, particularly illustrating surface projections;

FIG. 6 is a cross-sectional view of a T-bracket adhesive cover in accordance with a preferred embodiment of the present invention, particularly illustrating surface depressions;

FIG. 7 is a cross-sectional view of a T-bracket adhesive cover in accordance with a preferred embodiment of the present invention, particularly illustrating through-holes;

FIG. 8 is a fragmentary front view of a T-bracket adhesive cover in accordance with a preferred embodiment of the present invention, particularly illustrating injection-holes;

FIG. 8a is a cross-sectional view of the T-bracket adhesive cover shown in FIG. 8, taken along the line A-A; and

FIG. 9 is a cross-sectional view of a preferred embodiment of the present invention, particularly illustrating a fluidly applied cover.

### DESCRIPTION OF THE PREFERRED EMBODIMENTS

The present invention concerns an improved method of and apparatus for weld-bonding a plurality of workpieces. As previously mentioned, the method improves the construction process of a peel joint by preventing or reducing the amount of adhesive waste due to dripping. The method also enables the formation of a stronger joint due in part to the retention of more adhesive and the transfer of a portion of the load-carrying capacity of the joint to the shear strength of the adhesive interface. Those preferred embodiments of the present invention discussed herein, will be described in conjunction with the accompanying drawings. However, it is certainly within the ambit of the present invention, to utilize the novel features of the invention in other configurations not presented. For example, the invention can be modified to join a plurality of sheet metal workpieces greater than two, to join parts presenting other complex shapes, or to incorporate other connection/welding technologies, such as riveting, clinching, or laser spot welding.

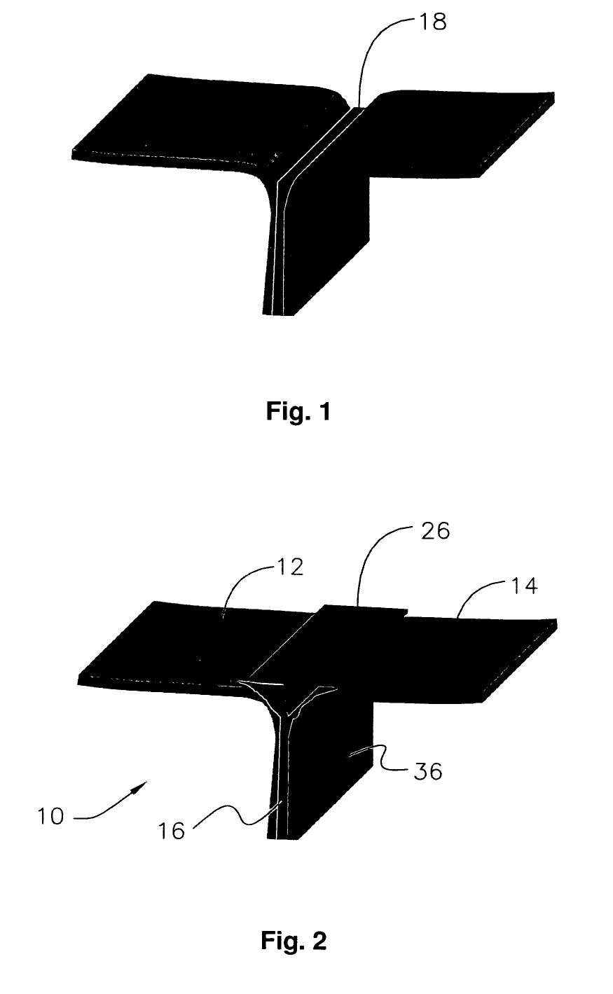

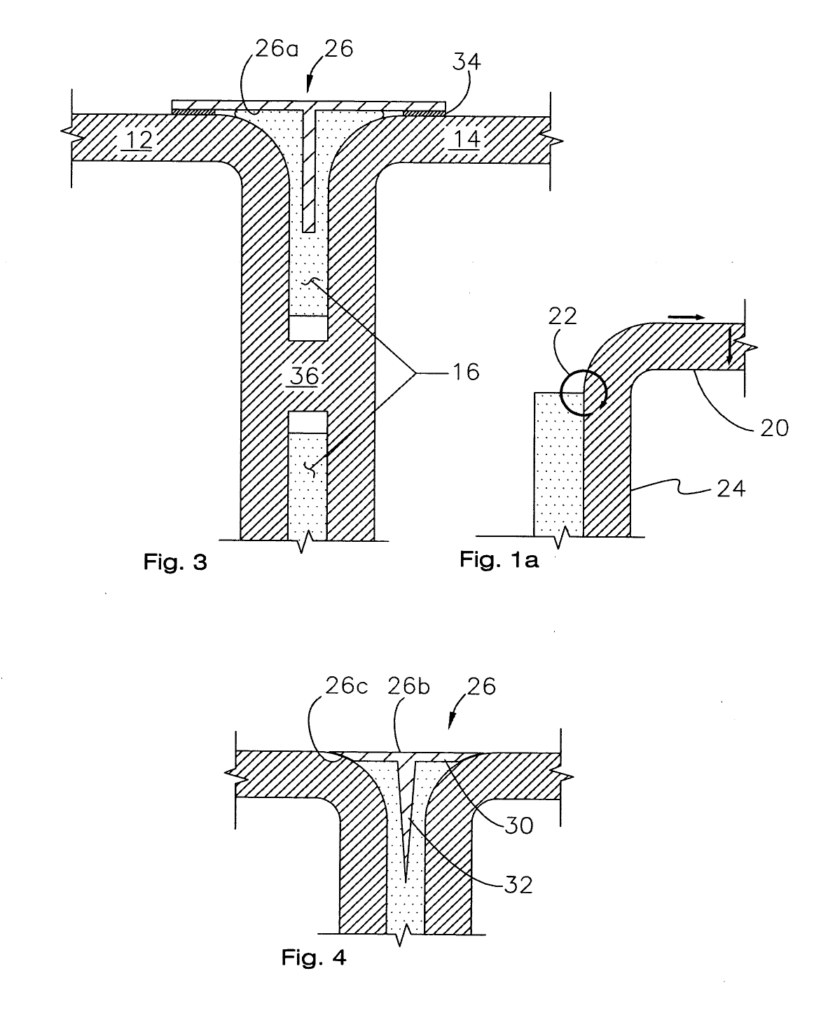

As shown in FIG. 2, the improved method of the present invention is operable to construct a weld-bonded assembly 10, which as illustrated, includes a plurality of two workpieces 12,14, an adhesive layer 16 interpositioned between and interconnecting the workpieces 12,14 and defining an exposed adhesive surface 18 (see, FIG. 1), and an adhesive cover securely fixed relative to the workpieces 12,14 and subtending the exposed adhesive surface 18, so as to cover or prevent the migration of the adhesive layer in that direction.

More particularly, the assembly 10 preferably includes two sheet metal workpieces 12,14, wherein each workpiece presents a ninety-degree bent configuration. It is appreciated by those ordinarily skilled in the art that the application of an outward force at the face of one leg 20 of the bent workpiece configuration results in the creation of a moment 22 or otherwise transfer of such forces, at the adjacent end of the other leg 24. Where the workpieces 12,14 are adhesively interconnected at that location, and the transferred forces are greater than the adhesive bond strength, as shown in FIG. 1a, peeling or cracking will occur. As best shown in FIG. 4, the bent workpieces present fillet edges having a constant radius as a result of the bending process.

Turning to the configuration of the weld-bond joint, an adhesive layer 16 interconnects the workpieces 12,14 adjacent at least one edge of the workpieces 12,14. The layer 16 is formed of adhesive material having sufficient physical properties to perform under anticipated conditions and stresses. For example, in automotive assembly, a one-part, high performance, heat-curing, structural epoxy adhesive can be utilized, such as Terokal 4555B manufactured by Henkel Corporation. The area to be bonded depends upon the size and function of the workpieces, and anticipated loads to be carried. The thickness of the layer 16 is sufficiently sized to enable the proper function and even application of the adhesive material, and is typically within the range of 0.25 to 2 mm thick.

As shown in FIG. 24, the assembly 10 includes an adhesive cover 26 fixedly secured relative to the workpieces 12,14. The cover 26 overlays the exposed adhesive surface 18 to prevent the migration of fluid adhesive in that direction during construction. The cover 26 may initially be attached to the workpieces directly or held in place either manually or via mechanical means (not shown). The cover 26 may be permenantly affixed to the assembly, or removable once curing is complete. The cover 26 may be positioned prior to or after the application of the adhesive layer 16. Where positioned prior to application, the cover more preferably defines at least one fluid adhesive inlet 28 configured to enable the ingress, but not the egress, of fluid adhesive material (see, FIG. 8). Finally, the cover 26 and adhesive layer 16 are cooperatively configured such that the layer 16 further contacts and adhesively bonds to an interior surface 26a of the cover angular, and more preferably, perpendicular to the adhesive/workpiece interfaces. It is appreciated that the configuration of this additional bond, which is at least in part parallel to the anticipated peeling forces, transfers a portion of the adhesive load-carrying capabilities of the joint to the greater shear strength of the adhesive interface.

More preferably, the cover 26 presents a T-bracket having first and second perpendicular panels 30,32 as shown in the illustrated embodiments. The first panel 30 presents a width greater than the exposed adhesive surface 18, and more preferably, at least equal to the maximum distance between the radial bends of the workpieces 12,14 as shown in FIGS. 3 and 4, so as to enable, where equal, the outer face 26b of the bracket to lay generally flush with the outer face of the workpieces 12,14, and where greater, the first panel 30 to overlap the gap created by the workpieces 12,14 adjacent the exposed adhesive surface 18. Where equal, the preferred first panel 30 further presents curved engaging surfaces 26c having a radius of curvature slightly larger than the maximum radius of bending of the workpieces. Where the bracket 26 overlays the workpieces 12,14, it is also appreciated that a second bonding layer or fastener 34 may be applied to directly attach the cover to the workpieces 12,14 (see, FIG. 3). Finally, the preferred bracket 26 may be formed of material selected from the group consisting essentially of mild steel, aluminum alloys, and hard ABS plastics.

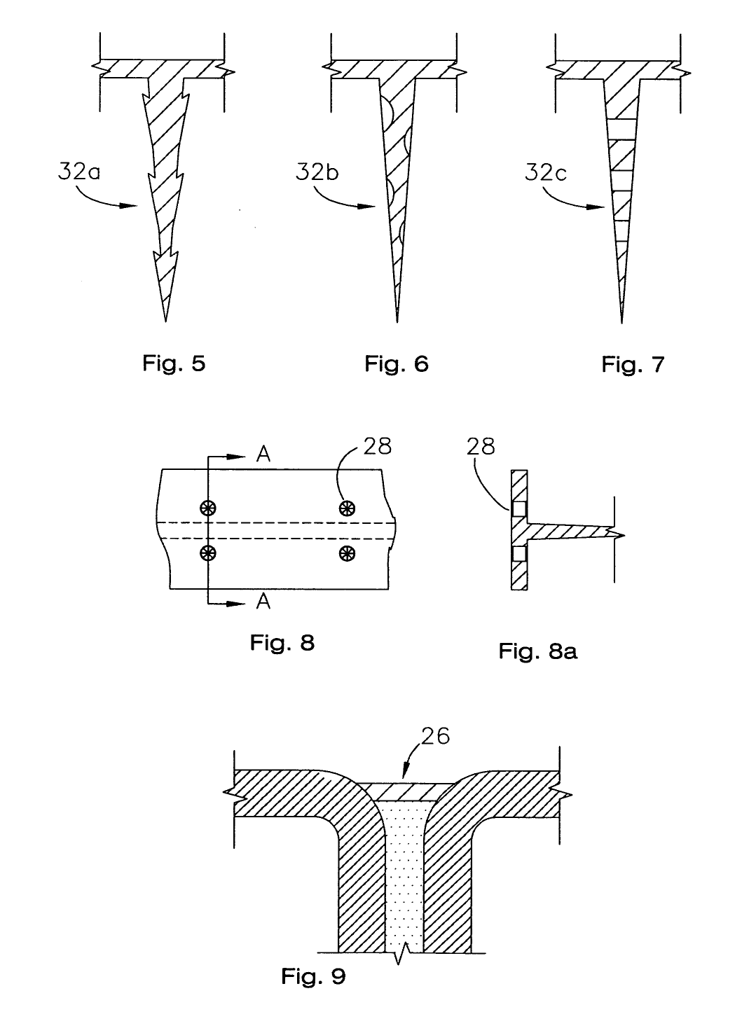

The second panel 32 is configured to be embedded into the fluid adhesive layer 16 a sufficient distance to secure the bracket 26 in place once the layer 16 cures, and as such presents a width less than the width of the layer 16, and more preferably less than one half of the width of the layer 16. More preferably, and as shown in FIG. 4, the second panel 32 tapers towards a distal edge so as to facilitate embedment into the pre-set layer 16. Care should be taken in orienting the bracket 26, so as not to interfere with bond formation between the layer 16 and workpieces 12,14. As shown in FIGS. 5 and 6, the second panel 32 may also define at least one surface projection or depression that increases the surface area of interaction with the adhesive layer 16. FIG. 5 illustrates a second panel 32a presenting angled projections that facilitate embedment but retards removal of the bracket 26, while FIG. 6 alternatively shows a second panel 32b that defines a series of depressions. Most preferably, however, the bracket 26 includes a second panel 32c that defines a plurality of through-holes, wherein the adhesive layer 16 passes through and solidifies to further secure the bracket 26.

It is certainly within the ambit of the present invention to modify the configuration of the bracket 26 to accommodate the workpieces or structural design. For example, where a plurality of three workpieces is presented the bracket 26 may include a third panel. The bracket 26 may be pre-conditioned or coated as desired to promote bonding to or release from the adhesive layer 16, or in anticipation of certain conditions. Finally, it is also within the ambit of the present invention to fluidly apply a ‘quick-setting’ cover layer either in fluid or particulate initial form directly to the exposed surface 18 (see FIG. 9), wherein the cover bonds to the workpieces 12,14. In this configuration, it is appreciated that the cover provides greater flexibility and is therefore more suitably applied to exposed adhesive surfaces 18 having sinuous or amorphous configurations or shapes.

The assembly 10 further includes a weld connection 36 between workpieces 12,14. More preferably, once the adhesive layer 16 has been applied and allowed to set, the workpieces 12,14 are spot welded at a location, so that the weld nugget 36 is formed within the adhesive layer 16. In other words, the layer 16 circumscribes the nugget 36, as shown in FIG. 3. It is appreciated by those ordinarily skilled that weld nugget formation is more preferably further positioned near clamped flexural node locations to minimize distortion within the workpieces. It is also appreciated that where spot welding succeeds the formation of the adhesive layer 16, heat energy produced during the formation of the nugget 36 causes the decomposition of a portion of the layer 16 adjacent the nugget 36, so that the circumscribed nugget 36 is spaced from the layer 16 (also shown in FIG. 3).

Thus, a method of weld-bonding a plurality of workpieces is presented, wherein an adhesive layer is secured intermediate and adjacent the workpieces, so as to interconnect the workpieces in a fixed relative position. The workpieces and layer cooperate to present an exposed adhesive surface. An adhesive cover is secured in a fixed position relative to the workpieces and exposed surface, so as to prevent the migration of adhesive material in that direction during construction. The adhesive layer is allowed to cure pursuant to the recommendations and procedure of the adhesive manufacturer. Finally, the workpieces are welded together to further secure the workpieces in the fixed position. These steps are not necessarily sequential, and could therefore, be performed in any order. More preferably, the weld is formed at a location at or near a flexural node, and the cover is pre-conditioned as desired. The cover may be permenantely fixed to the assembly 10, or removed and re-utilized over a plurality of weld-bond cycles, wherein each step is repeated.

Obvious modifications to the exemplary embodiments and methods of operation, as set forth herein, could be readily made by those skilled in the art without departing from the spirit of the present invention. As used herein, the term “plurality” shall mean two or more. The inventors hereby state their intent to rely on the Doctrine of Equivalents to determine and assess the reasonably fair scope of the present invention as pertains to any system not materially departing from but outside the literal scope of the invention as set forth in the following claims.

What is claimed is:

1. A structural assembly comprising:
a plurality of workpieces;
an adhesive material intermediate and in contact with the workpieces, so as to present an exposed adhesive surface; and
an adhesive cover configured and fixedly secured relative to the workpieces, so as to cover the exposed adhesive surface,
said material being configured to secure the workpieces in a relatively fixed position,
said workpieces being further connected, so as to further secure the workpieces in the fixed position.

2. The assembly as claimed in claim 1,
said workpieces being spot welded at a location, such that the spot weld is circumscribed by the material.

3. The assembly as claimed in claim 1,
said material being formed of an epoxy based adhesive.

4. The assembly as claimed in claim 1,
said cover including a T-shaped bracket having a first panel and a second panel projecting perpendicularly from the first panel,
said first panel presenting a width greater than the width of the exposed adhesive surface,
said second panel presenting a sufficient depth, such that at least a half of the second panel is embedded within the adhesive material.

5. The assembly as claimed in claim 4,
each of said workpieces presenting an angled bend having a filleted edge of constant radius,
said first panel presenting curved engaging surfaces and being further configured so as to cooperatively present a generally flush exterior assembly surface.

6. The assembly as claimed in claim 4,
said second panel presenting a sufficient depth and said material being configured, such that the second panel is fully embedded within the adhesive material and the material contacts the first panel.

7. The assembly as claimed in claim 1,
said cover presenting an initial fluid or particulate form, and being fluidly applied to the exposed adhesive surface.

8. A bracket adapted to interact with adhesive material during a method of joining multiple workpieces, wherein said material interconnects the workpieces and presents an exposed adhesive surface, said bracket comprising:
a first panel having a width greater than the width of the exposed adhesive surface and a length subtending the length of the surface, so that the surface is covered by the first panel, when the bracket is in place; and
a second panel connected to and angularly projecting from the first panel, and having a width less than the width of the exposed adhesive surface and a sufficient depth, so as to be embedded within the adhesive material a minimum distance, when the bracket is in place.

9. The bracket as claimed in claim 8,
said first panel presenting curved distal surface sections configured to form superjacent layers with curved portions of the workpieces, when the bracket is in place.

10. The bracket as claimed in claim 8,
said second panel being tapered towards a distal edge, so as to facilitate embedment.

11. The bracket as claimed in claim 8,
said first and second panel being integrally formed of a material selected from the group consisting essentially of mild steel, aluminum alloys, and hard ABS plastics.

12. The bracket as claimed in claim 8,
said first panel at least cooperatively defining an opening configured to allow the application and ingress, but not the egress, of the adhesive material, when the bracket is in place.

13. The bracket as claimed in claim 8,
said second panel presenting surface projections or depressions, so as to increase the surface area of contact with the adhesive material, when the bracket is in place.

14. The bracket as claimed in claim 13,
said second panel defining at least one through-hole operable to pass the adhesive material there-through.

15. A method of joining a plurality of workpieces, said method comprising the steps of:
a. securing an adhesive layer intermediate and adjacent the workpieces, so as to interconnect the workpieces in a fixed relative position and present an exposed adhesive surface;
b. securing an adhesive cover in a fixed position relative to the workpieces and exposed adhesive surface, so as to prevent the migration of adhesive in that direction during construction; and
c. further interconnecting the workpieces to further secure the workpieces in the fixed position.

16. The method as claimed in claim 15,
steps (b) and (c) further including the steps of bonding the adhesive layer to the cover along an interface perpendicular to the interfaces formed between the adhesive layer and the workpieces.

17. The method as claimed in claim 15,
step (b) further including the steps of embedding at least a portion of the cover within the adhesive layer, so as to secure the cover in the fixed position.

18. The method as claimed in claim 17,
step (b) further including the steps of pre-conditioning said at least portion of the cover with a releasing agent to facilitate the removal of the cover once the layer is cured.

19. The method as claimed in claim 15,
step (c) further including the steps of spot welding the workpieces at a flexural node location, wherein the spot weld is circumscribed by the layer.

20. The method as claimed in claim 15,
step (c) further including the steps of clinching or riveting the workpieces at a location circumscribed by the layer.
